(19) United States
(12) Patent Application Publication
(10) Pub. No.: US 2010/0265089 A1
(43) Pub. Date: Oct. 21, 2010

(54) EMERGENCY LOCATION FINDER

(76) Inventor: James Gregory, Avon, IN (US)

Correspondence Address: Woodard, Emhardt, Moriarty, McNett & Henry LLP, 111 Monument Circle, Suite 3700, Indianapolis, IN, 46204-5137, US

(21) Appl. No.: 12/760,835

(22) Filed: Apr. 15, 2010

Related U.S. Application Data
(60) Provisional application No. 61/169,905, filed on Apr. 16, 2009.
(60) Provisional application No. 61/221,798, filed on Jun. 30, 2009.

(51) Int. Cl. G08B 5/36

(52) U.S. Cl. 340/815.74

(57) ABSTRACT

A light system for identifying a target location for emergency vehicles, includes an outdoor light fixture and bulb, and an activation mechanism for selecting and changing between a “constant on” mode, a “constant off” mode, and a “blinking” mode. The system may use a dual use smart bulb that functions with standard hardware at the location for constant on and constant off modes, but is activated to emergency blinking mode by another device. The lighting system may be incorporated into or activated by a security or telephone system for alerting a homeowner or security company when an emergency is indicated at the location.

### REFERENCE TO RELATED APPLICATIONS

This application claims priority from U.S. Provisional Patent Application Ser. No. 61/169,905, filed Apr. 16, 2009, and from U.S. Provisional Patent Application Ser. No. 61/221,798, filed Jun. 30, 2009, both of which are hereby incorporated herein by reference in their entirety.

### BACKGROUND TO THE INVENTION

Various forms of emergency lighting systems and/or locator devices are known to the art. For example, U.S. Pat. No. 4,686,505 to Vanderburg discloses an emergency lighting apparatus which is activated by a homeowner in the event of an emergency. With that apparatus, transparent house numbers are illuminated from behind while a strobe light is flashed.

U.S. Pat. No. 5,880,672 discloses an emergency indicator system which comprises a telephone located within a building and a visual display unit. When a person dials 911 on the telephone during an emergency, a visual display unit is activated so that the building can quickly be located by emergency rescue vehicles.

U.S. Pat. No. 4,878,236 discloses an emergency locator system that detects tone dialing of an emergency number such as 911. Upon detecting of this number the system turns on a visual signal, such as a flashing strobe light.

U.S. Pat. No. 5,012,507 discloses a telephone activated emergency light system which passively monitors all dialing from particular premises and responds to the dialing of a predesignated emergency number by activating an indicator such as a strobe light.

U.S. Pat. No. 5,621,379 discloses a tone dialing activated emergency locator signal light system which monitors dialing from a telephone and responds to the dialing of a predetermined emergency number by activating a signal light device.

As will be shown below though, none of the prior art emergency light units provides all of the advantages and options of the emergency location finder described and claimed herein.

### SUMMARY OF THE INVENTION

A light system for identifying a target location for emergency vehicles, including a light fixture suitable for use outdoors, a bulb suitable for use in the fixture, and an activation mechanism for selecting and changing between a “constant on” mode, a “constant off” mode, and a “blinking” mode for the bulb when the bulb is provided in the fixture. The activation mechanism may include a first activation mechanism for selecting and changing between a “constant on” mode and a “constant off” mode, and a second activation mechanism for selecting and changing between a “blinking on” mode and a “constant off” mode. The activation mechanism may be activated manually, such as by a switch at the location, and/or remotely, such as through a land line telephone, a cellular telephone, a PDA device, a satellite signal, a radio frequency signal, or any form of remote signaling source. The remote signal may be controlled from essentially any remote signaling device, such as a key fob. The lighting system may be incorporated into or activated by a security system for alerting a homeowner or security company when an emergency is indicated at the location.

In one embodiment the lighting system comprises a “smart bulb” that may be used in any standard lighting fixture. The smart bulb includes an activation mechanism for selecting and changing between a “constant on” mode, a “constant off” mode, and a “blinking on” mode. The activation mechanism may be activated manually remotely as described above.

The smart bulb may be activated between its “constant on” and “constant off” modes using a standard light switch. The smart bulb may be activated to its “blinking” mode either by a standard switch or by another device, including automatic activation if a predetermined emergency number is called. The smart bulb may include a receiver for receiving a signal from a remote and/or wireless source so that the smart bulb may be operated as a normal outdoor (e.g., entry) light using the standard switch, but may be operated as an emergency location indicator using another activation device. In some embodiments the smart bulb may be used in this dual-use capacity without the need for the homeowner to purchase additional fixtures or hardware beyond the smart bulb itself.

### DESCRIPTION OF THE DRAWINGS

FIG. 1 shows a lighting system according to one embodiment of the present invention, installed on a house.

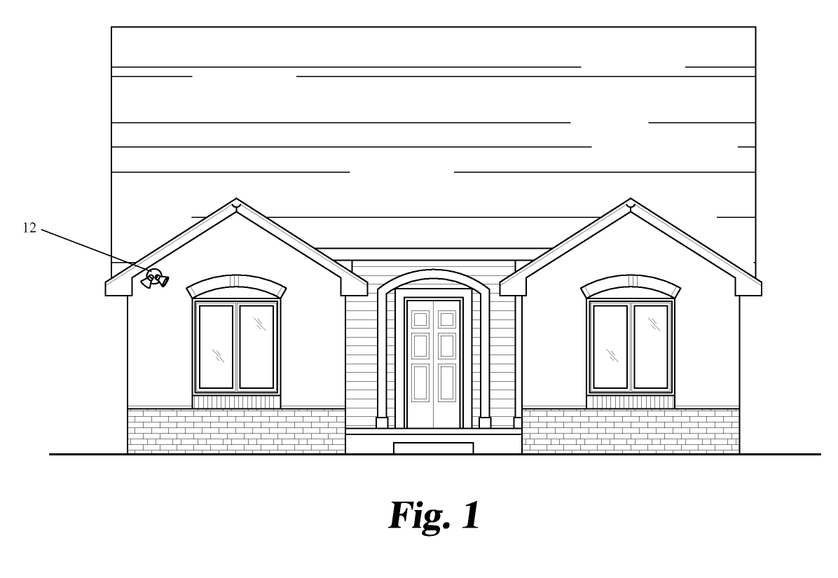

FIG. 2 shows a lighting system according to one embodiment of the present invention, incorporated into a home security system.

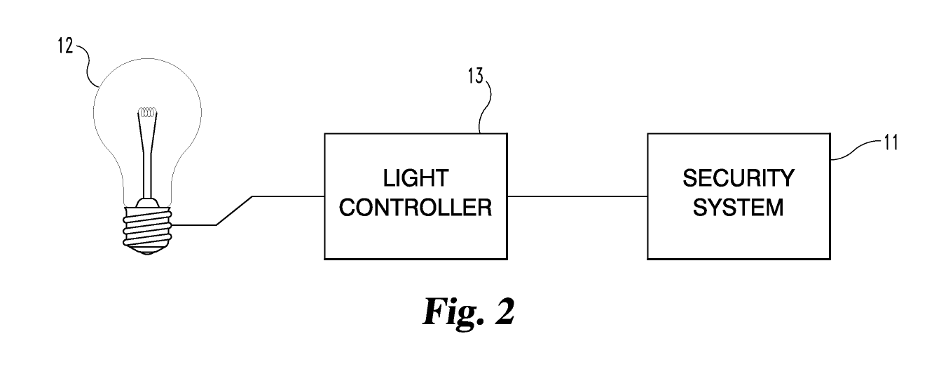

### DESCRIPTION OF PREFERRED EMBODIMENTS

For the purposes of promoting an understanding of the principles of the invention, reference is made herein to certain preferred embodiments and specific language will be used to describe the same. It will nevertheless be understood that no limitation of the scope of the invention is thereby intended, with such alterations and further modifications in the illustrated invention, and such further applications of the principles of the invention as illustrated therein, being contemplated as would normally occur to one skilled in the art to which the invention relates.

One aspect of the present invention relates to a light system for identifying a target location for emergency vehicles. The light system preferably includes a light fixture suitable for use outdoors, a bulb suitable for use in the fixture, and an activation mechanism for selecting and changing between a “constant on” mode, a “constant off” mode, and a “blinking” mode when the bulb is provided in the fixture.

The activation mechanism may be activated manually, such as by a switch at the location, and/or remotely, such as through a land line telephone, a cellular telephone, a PDA device, a satellite signal, or a radio frequency signal.

The activation mechanism may include a first activation mechanism for selecting and changing between a “constant on” mode and a “constant off” mode, and a second activation mechanism for selecting and changing between a “blinking on” mode and a “constant off” mode.

The lighting system may be incorporated into or activated by a security system for alerting a homeowner or security company when an emergency is indicated at the location.

The emergency lighting system includes lights that are preferably attached directly to or within the vicinity of a house or other building structure. In one embodiment, the lights are dual-purpose lights that are designed and adapted to act as standard porch, garage, driveway, or front entrance lights, etc. When activated, the lights flash intermittently, making it easier for emergency response personnel to locate the house during an emergency call.

In one embodiment the emergency lighting system comprises a “smart bulb” that may be used in any standard lighting fixture. The smart bulb includes an activation mechanism for selecting and changing between a “constant on” mode, a “constant off” mode, and a “blinking on” mode. The activation mechanism may be activated manually remotely as described above.

In one embodiment the smart bulb may be activated between its “constant on” and “constant off” modes using a standard light switch, and may be activated to its “blinking” mode either by a standard switch or by another device, including automatic activation if a predetermined emergency number is called. In other embodiments either a standard, wired switch or a wires activation mechanism may be used to switch between any and all of the smart bulb's three modes.

The smart bulb may include a receiver for receiving a signal from a remote and/or wireless source (such as a key fob) and activating the desired lighting mode. The receiver receives a wireless signal and selectively activates the activator to activate the bulb to a desired lighting mode (e.g., constant on, constant off, or blinking).

The “wireless” receiver may be used in conjunction with or instead of a wired activation mechanism. Accordingly, the smart bulb may be used as a dual-use light, where the smart bulb is operated as a normal outdoor (e.g., entry) light for normal use (using, for example, a standard, wired switch), but may be operated as an emergency location indicator when needed (using, for example, a wireless receiver activated by a key fob).

The smart bulb may be used to provide a dual-use emergency lighting system without the need for the homeowner to purchase additional fixtures or hardware beyond the smart bulb itself. Alternatively, a smart bulb may be packaged with a remote, wireless activation device such as a key fob.

The emergency lighting system may be connected to and operated in conjunction with a home security system, although the system may alternatively be activated manually by a direct-wire switch or a remote wireless device, such as a key fob. In other embodiments the device may be triggered automatically when a particular phone number is dialed (i.e., “911”). When the inventive system is incorporated into a security system or other “smart home” network, the homeowner, security system personnel, or even a 911 operator may remotely activate the device when response personnel have been dispatched.

In one aspect of the present invention the light system is incorporated into or activated by a security system (10) such as is known to the art for use with homes, offices, factories, warehouses, or other locations that it may be desired to provide with security. The security system generally may have sensors to detect when a potential emergency situation is indicated, such as the presence of an intruder, a fire, flooding, chemical spills, toxic vapors, or some other potential emergency.

The security system may be connected to a private security provider that monitors the system and dispatches emergency personnel if such action is needed. The system may be configured to notify the private security provider first and allow the private security provider to notify emergency personnel, or it may be configured simply to notify emergency personnel of the indicated emergency situation.

The details of home security systems that may be adapted to incorporate the emergency lighting system of the present invention are known to the art. For example, home security systems offered by Brinks and described at http://www.brinkshomesecurity.com are contemplated to be adaptable to function with the present invention, and the details of those systems are incorporated herein by reference. Similarly, home security systems offered by ADT and described at http://www.adt.com are contemplated to be adaptable to function with the present invention, and the details of those systems are incorporated herein by reference. Also, home security systems offered by Honeywell, GE, Visonic, SkyLink, DSC, Winn, Intella-Home, and others, described for example at http://www.homesecuritystore.com and/or at http://www.intellahome.com, are contemplated to be adaptable to function with the present invention, and the details of those systems are incorporated herein by reference.

Another element of the inventive system is an emergency lighting system that cooperates with the home security system to provide a strong visual indicator of the location of the home when the security system is instructed to provide the emergency location lights. The emergency lighting system may comprise one or more lights and a control system to control the lights.

The emergency light or lights (12) are preferably located on the outside of a building where they can easily be seen by emergency personnel. The lights may be adapted to flash to provide a more noticeable indicator. The lights may be “natural” white, or they may be colored red or another warning color. They may have a brightness common to standard porch lights (comparable to one or more 60 W to 100 W bulbs), or they may have a noticeably greater brightness or intensity. The lights are positioned so as to easily be noticed by emergency response personnel. For example, the lights may be on the building itself, or on another, nearby structure such as a mailbox or lamppost.

In one preferred embodiment the lights are “dual-use” lights that are adapted to serve as standard porch lights, outer garage area lights, front entry area lights, driveway lights, etc. The dual-use lights preferably have a manual switch for turning the lights on and off for their normal course of use. That is, the lights are designed and installed to function as decorative porch or outside area lighting, but they also are provided with a switch that bypasses the normal manual switch to cause the lights to flash to alert emergency personnel to the location of an emergency.

When “dual-use” lights are provided, it is preferred that the light fixture(s) be a decorative fixture such as is common for exterior home or office lighting. This avoids the unsightly appearance of standard “emergency-type” lights that are used solely in emergency situations.

The emergency light or lights are preferably controlled by a manual switch for their standard use as outside decorative lighting, and by an emergency light controller (11) for their use as emergency location identifiers. The controller may over-ride the manual switch and activate the lights when an emergency situation is indicated. The controller also may control the flashing of the lights.

The controller may be operated by the home security system, and/or by some other manual or remote switch or controller. In one embodiment the light controller activates the emergency lights automatically when the home security system detects an emergency situation. In another embodiment the light controller activates the lights when directed to do so by personnel monitoring the home security system.

The light controller preferably causes the lights to flash in a manner effective to draw attention from an emergency responder who is looking for the location. The light controller may be adapted to simultaneously or alternatively activate another visual or audio display to attract the attention of emergency personnel, such as an audio alarm.

In one alternative embodiment the emergency lighting system may be used without a home security system. In this embodiment the system comprises the light or lights and a controller to control the lights. As with the preferred embodiment described above, the light(s) is/are mounted to the exterior of a home, office, factory, store, warehouse, or any other location that it may be desired to provide with an emergency locator system. The light is controlled to flash as directed by the controller to indicate to emergency personnel the location of the emergency.

The emergency location finder of the present invention may be activated manually, or by an activation device such as a remote activation device on a key fob. The activation device, whether remote or incorporated into the controller, may be activated manually or my receiving a signal, such as an audio signal that may be as simple as the sound of a person clapping.

It is to be appreciated that the emergency location finder of the present invention may be used to identify a location in virtually any emergency, including a medical emergency as well as the intruder, fire, flooding, etc., emergencies that are more commonly protected by home, commercial, or industrial security systems.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A light system for identifying a target location for emergency vehicles, comprising:
a) a light fixture suitable for use outdoors;
b) a bulb suitable for use in said fixture; and
c) an activation mechanism for selecting and changing between a “constant on” mode, a “constant off” mode, and a “blinking on” mode for said bulb when the bulb is provided in said fixture.

2. A light system according to claim 1 wherein said activation mechanism comprises a first activation mechanism for selecting and changing between a “constant on” mode and a “constant off” mode, and a second activation mechanism for selecting and changing between a “blinking on” mode and a “constant off” mode.

3. A light system according to claim 1 wherein said activation mechanism is activated via a land line telephone.

4. A light system according to claim 3 wherein said activation mechanism is activated via a cellular telephone.

5. A light system according to claim 1 wherein said activation mechanism is activated via a PDA device.

6. A light system according to claim 1 wherein said activation mechanism is activated via a satellite signal.

7. A light system according to claim 1 wherein said activation mechanism is activated via a radio frequency signal.

8. A light system according to claim 1 wherein said activation mechanism is activated via key fob.

9. A method for using an outdoor to selectively provide constant light or to selectively blink on and off to identify a target location for an emergency vehicle, comprising:
a) providing a light system having:
i) a light fixture suitable for use outdoors;
ii) a bulb suitable for use in said fixture; and
iii) an activation mechanism for selecting and changing between a “constant on” mode, a “constant off” mode, and a “blinking on” mode for said bulb when the bulb is provided in said fixture;
b) activating said light system to its “constant on” mode when it is desired to provide constant light to an outdoor location;
c) deactivating said light system to its “constant off” mode when it is desired not to provide light to an outdoor location; and
d) activating said light system to its “blinking on” mode when it is desired to use the light system to identify a target location for an emergency vehicle.

10. A method according to claim 9 wherein said activation mechanism comprises a first activation mechanism for selecting and changing between a “constant on” mode and a “constant off” mode, and a second activation mechanism for selecting and changing between a “blinking on” mode and a “constant off” mode.

11. A method according to claim 9 wherein said activation mechanism is activated via a land line telephone.

12. A method according to claim 9 wherein said activation mechanism is activated via a cellular telephone.

13. A method according to claim 9 wherein said activation mechanism is activated via a PDA device.

14. A method according to claim 9 wherein said activation mechanism is activated via a satellite signal.

15. A method according to claim 9 wherein said activation mechanism is activated via a radio frequency signal.

16. A method according to claim 9 wherein said activation mechanism is activated via a key fob.

17. A system for assisting emergency personnel to locate a home or office during an emergency, the system comprising:
a) A security system for alerting a homeowner or security company when an emergency is indicated at a selected location;
b) One or more lights attached to the outside of said selected location; wherein said one or more lights are sized and positioned to light a porch or doorway area;
c) A manual switch for manually switching said one or more lights on to light a porch or doorway area; and
d) A light controller for bypassing said manual switch and for causing said one or more lights to flash when activated by said security system.

18. The system of claim 17 and further including an activator for allowing said one or more lights to be activated to their flashing condition upon manual or remote activation of the activator.

19. A smart bulb for dual use as a standard outdoor entry light or as an emergency location indicator for indicating the location of an emergency to emergency response personnel, comprising a light effective for indicating the location of an emergency to emergency response personnel, an activator for selectively activating the light to one of three modes, wherein said three modes are a constant on mode, a constant off mode, and a blinking mode, and a receiver for receiving a wireless signal and selectively activating the activator.
